(19) United States
(12) Patent Application Publication
(10) Pub. No.: US 2013/0196264 A1
(43) Pub. Date: Aug. 1, 2013

(54) ELECTROPHOTOGRAPHIC TONER AND METHOD FOR PRODUCING THE SAME

(71) Applicant: Toshiba Tec Kabushiki Kaisha, Tokyo (JP)

(72) Inventors: Takayasu Aoki, Shizuoka-ken (JP); Takafumi Hara, Shizuoka-ken (JP); Masahiro Ikuta, Shizuoka-ken (JP); Tsuyoshi Itou, Shizuoka-ken (JP); Motonari Udo, Shizuoka-ken (JP); Kazuhisa Takeda, Shizuoka-ken (JP)

(73) Assignee: TOSHIBA TEC KABUSHIKI KAISHA, Tokyo (JP)

(21) Appl. No.: 13/803,922

(22) Filed: Mar. 14, 2013

Related U.S. Application Data
(63) Continuation-in-part of application No. 13/664,704, filed on Oct. 31, 2012.
(60) Provisional application No. 61/564,087, filed on Nov. 28, 2011.

(51) Int. Cl. G03G 9/087

(52) U.S. Cl. CPC G03G 9/08755
USPC 430/109.4; 430/109.1; 430/137.14

(57) ABSTRACT

A decolorizable electrophotographic toner, including: toner particles, the toner particle comprising a binder resin; and colorant particles which contain an electron donating color developable agent, an electron accepting color developing agent, and a decolorizing temperature control agent, and have a capsule structure coated with an outer shell, wherein
the ratio of an total exposed areas of the colorant particles to the total projected areas of the toner particles calculated on the basis of scanning electron microscope (SEM) observation of the toner is 5.0% or less.

### CROSS-REFERENCE TO RELATED APPLICATION

This application is a continuation-in-part application of U.S. patent application Ser. No. 13/664,704 filed on Oct. 31, 2012, which application is based upon and claims the benefit of priority from: U.S. provisional application 61/564,087, filed on Nov. 28, 2011; the entire contents all of which are incorporated herein by reference.

### FIELD

Embodiments described herein relate generally to a technique for an electrophotographic toner.

### BACKGROUND

At present, digitization of information is proceeding, however, it is not suitable for viewing the entire information in a state of being displayed in a display. Therefore, although digitization is proceeding, the consumption amount of recording media (sheets) is increasing. In addition, in order to reduce CO₂ emission, the reduction of the consumption amount of sheets is demanded.

Therefore, a technique for outputting an image using a decolorizable toner is proposed. Such an image can be erased from the sheet output by a decolorizing treatment, whereby the sheet can be recycled.

However, further development of such a decolorizable toner is demanded.

### DESCRIPTION OF THE DRAWINGS

FIG. 1 is a process flow chart according to one example of a method for producing an electrophotographic toner of an embodiment.

FIG. 2 is a table showing the toners of Examples and Comparative Examples and the image densities of images formed by using each of the toners of Examples and Comparative Examples.

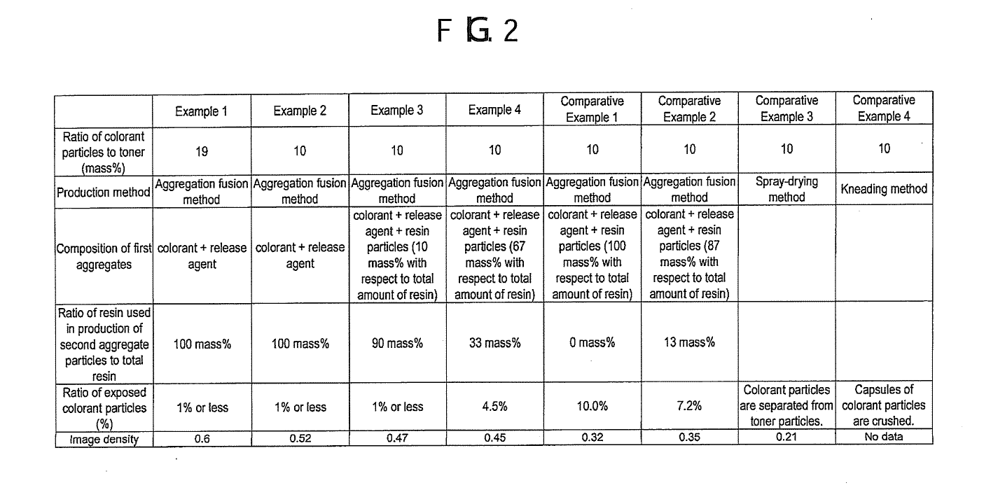

### DETAILED DESCRIPTION

A decolorizable electrophotographic toner (hereinafter sometimes simply referred to as a toner) of an embodiment includes: a binder resin; and colorant particles which contain an electron donating color developable agent, an electron accepting color developing agent, and a decolorizing temperature control agent, and have a capsule structure coated with an outer shell, wherein the ratio of total exposed areas of the colorant particles to the total projected areas of the toner particles calculated on the basis of scanning electron microscope (SEM) observation is 5.0% or less.

Hereinafter, embodiments will be described with reference to the drawings.

Although not particularly limited, the toner of the present embodiment can be produced by, for example, an aggregation fusion method in which the components of the toner are aggregated in a dispersion medium, followed by fusing the aggregates.

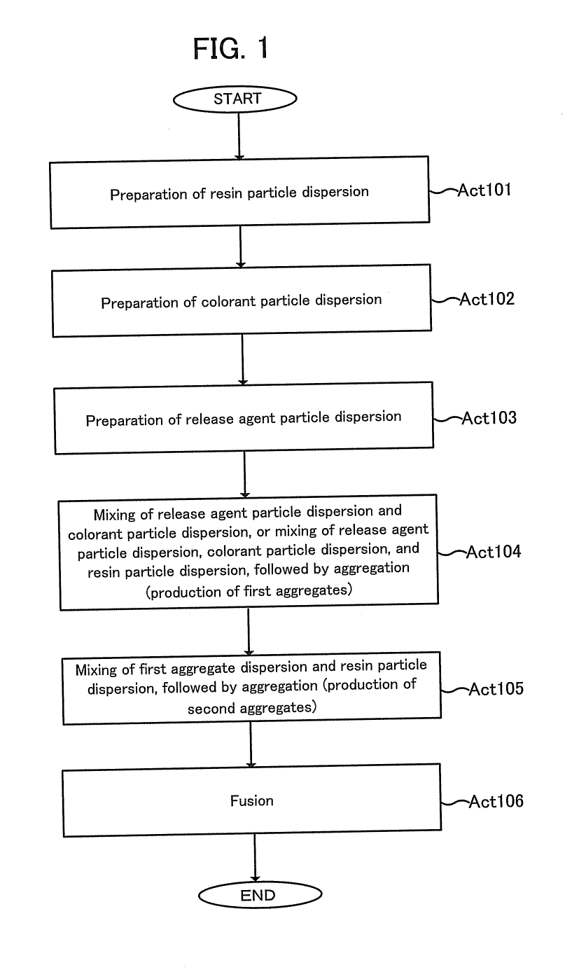

First, one example of a method for producing the toner of the present embodiment will be described with reference to the flow chart shown in FIG. 1.

The colorant particles as used herein refer to particles of a compound or a composition which impart color to a toner. The colorant particles of the present embodiment contain an electron donating color developable agent and an electron accepting color developing agent. In addition, the colorant particles of the present embodiment further contain a decolorizing temperature control agent that promotes decolorization of the toner by inhibiting the binding between the electron donating color developable agent and the electron accepting color developing agent.

In the following description, as the toner of the present embodiment, a toner containing a release agent in addition to the colorant particles and the binder resin will be described.

First, in Act 101 to Act 103, a resin particle dispersion, a colorant particle dispersion, and a release agent particle dispersion are prepared.

A method for preparing the respective particle dispersions is not particularly limited and can be appropriately selected by those skilled in the art. Examples thereof may include an emulsion polymerization method, a mechanical emulsification method, a phase inversion emulsification method, and a melting emulsification method. Further, the surface of each particle produced may be encapsulated by an interface polymerization method, an in situ polymerization method, a coacervation method, an in-liquid drying method, an in-liquid curing coating method, etc. In the present embodiment, the colorant particles have a capsule structure coated with an outer shell.

As a dispersion medium to be used in the preparation of the dispersion, for example, water, an alcohol such as ethanol or glycerin, or a water-soluble organic solvent such as glycol ether may be used.

In the present embodiment, the volume average particle diameter of the release agent particles is preferably smaller than that of the colorant particles, and the volume average particle diameter of the resin particles is preferably smaller than that of the release agent particles.

The volume average particle diameter of the colorant particles is preferably 0.5 μm to 5 μm. When the volume average particle diameter of the colorant particles is set to a range of 0.5 μm to 5 μm, the charge stability and the storage stability of the toner, and the color developability of the toner can be enhanced.

From the viewpoints of charge stability and storage stability, the volume average particle diameter of the resin particles is preferably about 0.01 μm to 1.0 μm, and more preferably 0.05 μm to 0.5 μm.

The volume average particle diameter as used herein refers to a particle diameter of a particle in the dispersion which is measured as a volume median diameter (D50) by a laser diffractive scattering method. In the present embodiment, the volume average particle diameter can be measured using, for example, SALD-7000 manufactured by Shimadzu Corporation.

In an aspect of the present embodiment, the resin particle dispersion, the colorant particle dispersion, and the release agent particle dispersion are prepared in Act 101 to Act 103, however the order of the preparation of the dispersions is not particularly limited as long as the preparation of the dispersions is performed before mixing of the dispersions.

In Act 104, the colorant particle dispersion and the release agent particle dispersion are mixed, and the colorant particles and the release agent particles are aggregated in the obtained dispersion of the colorant particles and the release agent particles, thereby producing first aggregates.

A method for producing the first aggregates is not particularly limited, and examples thereof may include an aggregation method by use of a metal salt or by adjustment of pH, and a method for mixing colorant particles and release agent particles, which were prepared so as to have zeta potentials with different signs from each other, to aggregate these particles. In the first aggregates, the release agent particles having a volume average particle diameter smaller than that of the colorant particles are disposed outside the colorant particles. The first aggregates may further contain components other than the colorant particles and the release agent particles. Specifically, the first aggregates of the present embodiment may be formed by aggregating colorant particles, release agent particles, and resin particles.

In Act 105, a resin particle dispersion is mixed in the dispersion of the first aggregates obtained in Act 104 to aggregate the first aggregates and the resin particles in the dispersion of the first aggregates and the resin particles. Thus, second aggregates are produced. A method for aggregating the first aggregates and the resin particles is not particularly limited, and examples thereof may include a hetero aggregation method. In addition, the second aggregates may further contain components other than the colorant particles, the release agent particles, and the resin particles.

In the toner of the present embodiment, the colorant particles have a relatively large particle diameter for the particle diameter of the toner particle, and therefore, in order to more reliably incorporate the colorant in the toner, it is preferred to dispose the colorant in a center region of the toner as much as possible.

In order to produce such a toner, a method in which resin particles are almost not added in the step of producing first aggregates, and resin particles are added in the step of producing second aggregates may be contemplated. In other words, the following method can be contemplated. In the step of producing first aggregates, the colorant particles, the release agent particles, etc. are aggregated, so that each of the resulting aggregates is disposed in the vicinity of a center region of the toner. Then, the resin particles are added in the step of producing second aggregates, and are aggregated so that the resin particles are disposed outside the first aggregates, thereby coating the first aggregates with the resin.

In this case, it is not necessary to add the resin particles to the first aggregates, however, the resin may be contained in the first aggregates in an amount of about 15% or less with respect to the total amount of the resin contained in the toner particles. If the amount thereof exceeds 15%, the colorant may not sufficiently coated with the resin, etc.

In the above method, the main components of the first aggregates are not the resin particles, but the colorant particles and the release agent particles.

Alternatively, as another method, a method in which in the step of producing first aggregates, a colorant, a release agent, and resin particles are dispersed in a dispersion liquid, and the aggregation of the resin particles is allowed to proceed while controlling the condition so as to coat the colorant and the release agent with the resin particles can be contemplated. In this case, the ratio of the amount of the resin particles to be used in the step of producing first aggregates to that of the resin particles to be used in the step of producing second aggregates is preferably in a range of 2:1 to 1:1. If the ratio of the amount of the resin particles to be used in the step of producing first aggregates is less than the above range, the incorporation of the colorant particles by the resin particles is not sufficient, and therefore, the color developability may be deteriorated. Further, if the ratio of the amount of the resin particles to be used in the step of producing first aggregates to that of the resin particles to be used in the step of producing second aggregates is more than 2:1, the coating of the first aggregates with the resin particles is not sufficient, and therefore, the exposure of the colorant particles may be increased. In the above method, the main components of the first aggregates are the resin particles.

In Act 106, a surfactant is added if necessary, and fusion is performed by heating to produce toner particles.

The fusing temperature is not particularly limited and can be appropriately determined by those skilled in the art. In general, the fusing temperature is set to a temperature equal to or higher than the glass transition temperature Tg of the resin. Therefore, when the decolorizing temperature at which the colorant is decolorized is lower than the fusing temperature, the color is erased in the fusing step. Accordingly, it is preferred to design the colorant such that the decolorizing temperature of the colorant is higher than the fusing temperature.

When the resulting toner particles are used in a dry-type electrophotographic device, post-treatments such as washing, drying, and external addition are performed. When the resulting toner particles are used in a wet-type electrophotographic device, drying and the like may not be performed appropriately, and a material for adjustment of a dispersion may be added as needed.

The thus produced toner has a release agent layer formed of release agent particles, which is disposed outside the colorant, and a binder resin layer formed of resin particles, which is disposed outside the release agent layer. In the toner of the present embodiment, the colorant is coated with the release agent layer and the binder resin layer disposed outside the release agent layer.

Hereinafter, the components of the toner which can be used in the present embodiment will be described. In the present embodiment, an aggregating agent, a surfactant, a pH adjusting agent, etc. may be used in the process of the production. These members will be also described below.

The contents of the toner components, the amounts of the aggregating agent, and the like, are not particularly limited and can be appropriately determined by those skilled in the art.

### Colorant Particles

In the present embodiment, the colorant particles in the toner contain an electron donating color developable agent, an electron accepting color developing agent, and a decolorizing temperature control agent. The ratios of the electron donating color developable agent, the electron accepting color developing agent, and the decolorizing temperature control agent in the colorant particles are not particularly limited and can be appropriately determined by those skilled in the art.

The electron donating color developable agent is a dye precursor compound to be used for displaying characters, figures, etc. In the present embodiment, the electron donating color developable agent is not particularly limited and can be appropriately determined by those skilled in the art, however, for example, a leuco dye can be used. Examples of the leuco dye may include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof may include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzo furan]-3′-one, 2-(diethylamino)-8-(diethylamino)-4-methyl-, spiro[5H-(1)benzopyrano(2,3-d)pyrimidine-5,1′(3′H)isobenzo furan]-3′-one, 2-(di-n-butylamino)-8-(di-n-butylamino)-4-methyl-, spiro[5H-(1)benzopyrano(2,3-d)pyrimidine-5,1′(3′H)isobenzo furan]-3′-one, 2-(di-n-butylamino)-8-(diethylamino)-4-methyl-, spiro[5H-(1)benzopyrano(2,3-d)pyrimidine-5,1′(3′H)isobenzo furan]-3′-one, 2-(di-n-butylamino)-8-(N-ethyl-N-1-amylamino)-4-methyl-, spiro[5H-(1)benzopyrano(2,3-d)pyrimidine-5,1′(3′H)isobenzo furan]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. In addition, examples thereof may include pyridine compounds, quinazoline compounds, and bisquinazoline compounds. These compounds may be used by mixing two or more kinds thereof.

The electron accepting color developing agent is an electron accepting compound which imparts a proton to the electron donating color developable agent such as a leuco dye. Examples of the electron accepting color developing agent may include phenols, metal salts of phenols, metal salts of carboxylic acids, aromatic carboxylic acids, aliphatic carboxylic acids having 2 to 5 carbon atoms, benzophenones, sulfonic acids, sulfonate salts, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole and derivatives thereof, which has an alkyl group, an aryl group, an acyl group, an alkoxycarbonyl group, a carboxyl group, esters thereof, an amido group, or a halogen group as a substituent, bisphenols, trisphenoles, phenol-aldehyde condensation resins, and metal salts thereof. These compounds may be used by mixing two or more kinds thereof.

Specific examples of the electron accepting color developing agent may include phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid and esters thereof, such as 2,3-dihydroxybenzoic acid and methyl 3,5-dihydroxybenzoate, resorcinol, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol. These compounds may be used by mixing two or more kinds thereof.

As the decolorizing temperature control agent, any known compound can be used as long as the compound can make a material colorless in a three-component system of an electron donating color developable agent, an electron accepting color developing agent, and a decolorizing temperature control agent by inhibiting the coloring reaction between the electron donating color developable agent and the electron accepting color developing agent through heating.

The decolorizing temperature control agent has an excellent instantaneous erasing property in a coloring and decolorizing mechanism utilizing the temperature hysteresis of a decolorizing temperature control agent disclosed in JP-A-60-264285, JP-A-2005-1369, JP-A-2008-280523, etc. When a mixture of such a three-component system in a colored state is heated to a specific decolorizing temperature Th or higher, the mixture can be decolorized. Even if the decolorized mixture is cooled to a temperature equal to or lower than Th, the decolorized state is maintained. When the temperature of the mixture is further decreased, a coloring reaction between the leuco dye and the color developing agent is restored at a specific color restoring temperature Tc (the solidifying point of the decolorizing temperature control agent) or lower, and the mixture returns to a colored state. In this manner, it is possible to cause a reversible coloring and decolorizing reaction. In particular, it is preferred that the decolorizing temperature control agent to be used in the present embodiment satisfies the following relation: Th>Tr>Tc, wherein Tr represents room temperature.

Examples of the decolorizing temperature control agent capable of causing this temperature hysteresis may include alcohols, esters, ketones, ethers, and acid amides.

Particularly, as the decolorizing temperature control agent, esters are preferred. Specific examples thereof may include esters of carboxylic acids containing a substituted aromatic ring, esters of carboxylic acids containing an unsubstituted aromatic ring with aliphatic alcohols, esters of carboxylic acids containing a cyclohexyl group in each molecule, esters of fatty acids with unsubstituted aromatic alcohols or phenols, esters of fatty acids with branched aliphatic alcohols, esters of dicarboxylic acids with aromatic alcohols or branched aliphatic alcohols, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These compounds may be used by mixing two or more kinds thereof.

From the viewpoint of color developability of the toner, etc., the volume average particle diameter of the colorant particles to be contained in the toner is preferably 0.5 μm to 5 μm.

The content of the colorant particles in the toner is not particularly limited, but can be set to 0.5 to 40 parts by mass with respect to 100 parts by mass of the toner.

In this specification, the content of one toner component in the toner refers to the content of the toner component with respect to the total amount of all the components contained in the toner particles. That is, the content of one toner component in the toner refers to the content of the toner component with respect to the total amount of all the components excluding external additives.

### Binder Resin

In the present embodiment, a resin contained in the resin particles and capable of being used as a binder is not particularly limited, and for example, either of a polyester resin and a styrene resin can be used. However, a polyester resin obtained by subjecting a dicarboxylic acid component and a diol component to an esterification reaction followed by polycondensation is preferred. In general, a styrene resin has a glass transition temperature higher than a polyester resin. Therefore, from the viewpoint of low-temperature fixation, a polyester resin obtained by subjecting a dicarboxylic acid component and a diol component to an esterification reaction followed by polycondensation is preferred.

Examples of the dicarboxylic acid component may include aromatic dicarboxylic acids such as terephthalic acid, phthalic acid, and isophthalic acid, and aliphatic carboxylic acids such as fumaric acid, maleic acid, succinic acid, adipic acid, sebacic acid, glutaric acid, pimelic acid, oxalic acid, malonic acid, citraconic acid, and itaconic acid.

Examples of the diol component include aliphatic diols such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol, alicyclic diols such as 1,4-cyclohexanediol and 1,4-cyclohexanedimethanol, ethylene oxide adducts of bisphenol A or propylene oxide adducts of bisphenol A.

Further, the components in the polyester resin may be converted so as to have a crosslinking structure using a crosslinking agent such as a trivalent or higher polyvalent carboxylic acid component or a trihydric or higher polyhydric alcohol component such as 1,2,4-benzenetricarboxylic acid (trimellitic acid) or glycerin.

A mixture of two or more polyester resins having different compositions may be used as the binder resin.

The polyester resin may be crystalline or amorphous.

The glass transition temperature Tg of the polyester resin is preferably 35° C. to 70° C., and more preferably 50° C. to 65° C. When the glass transition temperature Tg of the polyester resin is lower than 35° C., the heat resistance and the storage stability of the toner are decreased, and further, gloss derived from the resin when erasing is noticeable in comparison with a polyester resin having a glass transition temperature within the above range. Further, from the viewpoints of low-temperature fixability and decolorizing property, the glass transition temperature Tg of the polyester resin is preferably 70° C. or lower.

In the present embodiment, the content of the binder resin in the toner is not particularly limited, but can be set to 20 to 99 parts by mass with respect to 100 parts by mass of the toner. According to the above-described method for producing a toner in which after forming the first aggregates, the first aggregates and the resin particles are aggregated to form the second aggregates, even if the content of the binder resin is decreased in comparison with the conventional aggregation method, the charge stability and the storage stability can be maintained. In other words, according to the present embodiment, the color developability and the low-temperature fixability of the toner can be improved by increasing the contents of the colorant and the release agent while maintaining the charge stability and the storage stability.

In the toner of the present embodiment, other than the binder resin and the colorant particles, other components such as a release agent and a charge control agent which amount to 100 may be contained.

### Release Agent

Examples of a release agent may include aliphatic hydrocarbon waxes such as low-molecular weight polyethylenes, low-molecular weight polypropylenes, polyolefin copolymers, polyolefin waxes, paraffin waxes, and Fischer-Tropsch wax and modified substances thereof, vegetable waxes such as candelilla wax, carnauba wax, Japan wax, jojoba wax, and rice wax, animal waxes such as bees wax, lanolin, and spermaceti wax, mineral waxes such as montan waxes, ozokerite, and ceresin, fatty acid amides such as linoleic acid amide, oleic acid amide, and lauric acid amide, functional synthetic waxes, and silicone-based waxes.

In the present embodiment, as the release agent, particularly, a release agent having an ester bond of a component composed of an alcohol component and a carboxylic acid component is preferred. Examples of the alcohol component include higher alcohols, and examples of the carboxylic acid component include saturated fatty acids having a linear alkyl group, unsaturated fatty acids such as monoenoic acid and polyenoic acid, and hydroxy fatty acids. Further examples of the carboxylic acid component include unsaturated polyvalent carboxylic acids such as maleic acid, fumaric acid, citraconic acid, and itaconic acid. Further, an anhydride thereof may also be used.

From the viewpoint of low-temperature fixability, the softening point of the release agent is 50° C. to 120° C., more preferably 60° C. to 110° C.

The content of the release agent in the toner is not particularly limited, but can be set to 0.5 to 40 parts by mass with respect to 100 parts by mass of the toner.

### Reactive Polymer

In the toner of the present embodiment, a crosslinking agent which reacts with a binder resin to crosslink the binder resin may be used, and specifically, as the crosslinking agent, a polymer having an ability to react with a binder resin to crosslink the binder resin (hereinafter referred to as a reactive polymer) may be used. Examples thereof include reactive polymers having an oxazoline group. When the toner is produced by an aggregation fusion method, the reactive polymer is preferably soluble in water, and preferred examples of a commercially available product include “Epocros WS-500” and “EPOCROS WS-700”, manufactured by Nippon Shokubai Co., Ltd.

Further, as another reactive polymer, a compound having an epoxy group can be used, and examples thereof include DENACOL EX-313, 314, 421, 512, and 521, manufactured by Nagase ChemteX Corporation. These compounds having an epoxy group may be used alone if the toner binder resin is a resin having a carboxyl group (a polyester resin or a polystyrene resin having an acid value). Further, a substance having an amino group or a hydroxyl group may be added.

By using such a reactive polymer, it becomes possible to more reliably incorporate the colorant particles into the toner. As a result, an effect of improving image density when printing or improving image defects such as fogging can be exhibited.

A method for adding such a reactive polymer to the toner is not particularly limited, but for example, when the toner is produced by an aggregation fusion method, the reactive polymer can be added to the toner by being mixed with other components when performing a fusion treatment.

### Charge Control Agent

As the charge control agent, a metal-containing azo compound is used, and a complex or a complex salt, in which the metal element is iron, cobalt, or chromium, or a mixture thereof is preferred. A metal-containing salicylic acid derivative compound is also used, and a complex or a complex salt, in which the metal element is of zirconium, zinc, chromium, or boron, or a mixture thereof is preferred.

A method for adding such a charge control agent to the toner is not particularly limited, but for example, the charge control agent can be added to the toner by being mixed in a resin particle dispersion in the preparation of the dispersion.

### Aggregating Agent

An aggregating agent which can be used in the present embodiment is not particularly limited, and a strong cationic aggregating agent such as a monovalent metal salt such as sodium chloride, a polyvalent metal salt such as magnesium sulfate or aluminum sulfate, a nonmetal salt such as ammonium chloride or ammonium sulfate, an acid such as hydrochloric acid or nitric acid, polyamine, or polyDADMAC can be appropriately used.

### Surfactant

In the present embodiment, a surfactant can be used if necessary. The surfactant is not particularly limited, and for example, an anionic surfactant such as a sulfate salt-based, sulfonate salt-based, phosphate ester-based, or fatty acid salt-based surfactant, a cationic surfactant such as an amine salt-based or quaternary ammonium salt-based surfactant, an amphoteric surfactant such as a betaine-based surfactant, a nonionic surfactant such as a polyethylene glycol-based, alkylphenol ethylene oxide adduct-based, or polyhydric alcohol-based surfactant, or a polymeric surfactant such as polycarboxylic acid can be appropriately used. In general, such a surfactant is added in order to impart dispersion stability such as stability of aggregated particles. Further, a reversed polar surfactant or the like may be used as an aggregating agent.

### pH Adjusting Agent

In the present embodiment, a pH adjusting agent can be used to control the pH in a system, if necessary. The pH adjusting agent is not particularly limited, and for example, a basic compound such as sodium hydroxide, potassium hydroxide, or an amine compound can appropriately be used as an alkali, and an acidic compound such as hydrochloric acid, nitric acid, or sulfuric acid can appropriately be used as an acid.

### External Additive

In the present embodiment, in order to adjust the fluidity or chargeability of the toner particles, inorganic particles may be externally added to the toner particles in an amount of 0.01 to 20% by mass with respect to the amount of the toner particles. As such inorganic particles, silica, titania, alumina, strontium titanate, tin oxide, and the like can be used alone or by mixing two or more kinds thereof. It is preferred that as the inorganic particles, those surface-treated with a hydrophobizing agent are used from the viewpoint of improvement of environmental stability. Further, other than such inorganic oxides, resin particles having a size of 1 μm or less may be externally added for improving the cleaning property.

The toner of the present embodiment comprises a plurality of toner particles. The toner is configured such that the ratio of total exposed areas of the colorant particles to the total projected area of the toner particles calculated on the basis of scanning electron microscope (SEM) observation is 5.0% or less. Examples of the SEM include ULTRA 55 manufactured by Carl Zeiss Co., Ltd. The ratio of an exposed area of the colorant particles can be obtained by, for example, as follows. The colorant exposed on the surface when the toner is magnified to 2000 times at an acceleration voltage of 2.0 kV is counted, and the ratio can be calculated from the percentage of the exposed colorant to the entire toner. The SEM observation is performed in a state where the external additive is not externally added to the toner particles.

By setting the ratio of an exposed areas of the colorant particles to 5.0% or less, even if shear stress is applied to the toner in the post-treatment such as drying or by stirring in a developing device in MFP, the colorant is kept incorporated in the toner, and therefore, a toner providing an excellent image density can be obtained in the end.

In the present embodiment, the particle diameter of the toner is not particularly limited, but from the viewpoint of developability of an electronic photograph, the volume average particle diameter of the toner is preferably 5 to 20 μm. The particle diameter of the toner used herein refers to a volume average particle diameter measured in a state where the external additive is not externally added to the toner. For example, by measuring the volume average particle diameter of the toner particles which are not subjected to washing and drying after a fusion treatment, the value can be obtained.

When the toner of the present embodiment is used in, for example, a dry-type electrophotographic device, the toner is filled in a toner cartridge as a non-magnetic one-component developer or a two-component developer and the cartridge is mounted on an image forming apparatus such as a multifunction-peripheral (MFP), and can be used in the formation of an image on a recording medium. When the toner is used in a two-component developer, a carrier which can be used is not particularly limited and can be appropriately selected by those skilled in the art. When the toner is used in a wet-type electrophotographic device, the toner is mounted on an image forming apparatus as a dispersion in which the toner is dispersed in a carrier liquid, and can be used in the formation of an image on a recording medium in the same manner as in the dry-type electrophotographic device.

In an image formation process, a toner image formed using the toner of the present embodiment transferred onto a recording medium is heated at a fixing temperature, and a resin is melted to penetrate in the recording medium. The resin is then solidified to form an image on the recording medium (fixing treatment).

In general, in order to fix the toner, the temperature should be higher than the glass transition temperature Tg of the binder resin and also at least in the vicinity of the melting temperature Tm of the binder resin. Further, when the toner of the present embodiment is used, in order not to decolorize the toner during fixing, the fixing temperature should be equal to or lower than the decolorizing temperature Th.

The image formed on the recording medium can be erased by performing a decolorizing treatment of the toner. Specifically, the decolorizing treatment can be performed as follows. The recording medium having an image formed thereon is heated at a heating temperature equal to or higher than the decolorizing temperature Th to unbind the binding between a color developable agent and a color developing agent.

In the present embodiment, a decolorizing temperature control agent is contained in the colorant particles. In the case of containing a decolorizing temperature control agent having a solidifying point equal to or lower than normal temperature, when the toner is heated to a temperature equal to or higher than the melting point of the decolorizing temperature control agent, the toner is decolorized, and the decolorized state is maintained even at normal temperature.

Hereinafter, the method for producing a toner according to the present embodiment will be described in detail by Examples, however, the embodiment is not limited to the Examples.

Toners of Examples and Comparative Examples were produced, and the SEM measurement of the toners, the measurement of image densities of images formed using the respective toners, and the confirmation of the decolorizing performance were performed.

### SEM Measurement and Calculation of Ratio of Exposed Colorant Particles

In the SEM measurement, ULTRA 55 manufactured by Carl Zeiss Co., Ltd. was used. Projected area of each toner particle can be calculated based on an observed diameter of the toner particle when it is assumed that the each toner particle is circle. A major axis and short axis are used for the calculation if the each toner particle is assumed to be ellipse. The colorant particles exposed on the surface were counted when the toner is magnified to 2000 times at an acceleration voltage of 2.0 kV, and each exposed area of colorant is calculated with the same method as the calculation of the projected area. The ratio of the total exposed areas of colorant particles to the total projected areas of toner particles was calculated.

The projected areas of toner particles or the exposed areas Of the colorant particles can also be measured with an image analysis of a photograph of the toner particles. It is desirable that not less than 10 toner particles, more preferably 100 toner particles, are used for the observation by SEM measurement.

### Production of Amorphous Polyester Resin A

53.1 Parts by mass of polyoxypropylene (2.2)-2,2-bis(4-hydroxyphenyl)propane, 21.1 parts by mass of polyoxyethylene (2.0)-2,2-bis(4-hydroxyphenyl)propane, 22.6 parts by mass of fumaric acid, 3.2 parts by mass of adipic acid, 0.1 parts by mass of tert-butyl catechol, and 0.5 parts by mass of tin octylate were mixed. The resulting mixture was heated to 210° C. in a nitrogen atmosphere, and a reaction was allowed to proceed at 210° C. Thereafter, a condensation reaction was allowed to proceed under reduced pressure of 8.3 KPa until the softening point reached a desired value, whereby an amorphous polyester resin A was obtained.

### Production of Resin Particle Dispersion A

In a 5-L stainless vessel, 600 parts by mass of the amorphous polyester resin A, 40 parts by mass of an anionic surfactant “NEOPELEX G-15 (manufactured by Kao Corporation)” sodium dodecylbenzene sulfonate (solid content: 15% by mass), 6 parts by mass of a nonionic surfactant “EMULGEN 430 (manufactured by Kao Corporation)” polyoxyethylene (26 mol) oleyl ether, and 218 parts by mass of a 5% by mass aqueous solution of potassium hydroxide were dispersed at 25° C. by stirring at 200 r/m. Thereafter, the resulting dispersion was heated to 90° C. The dispersion was stabilized at 90° C. and maintained for 2 hours under stirring. Then, 1076 parts by mass of deionized water was added dropwise to the dispersion at 6 g/min, whereby an emulsion was obtained. After cooling the emulsion, the emulsion was passed through a metal mesh, whereby a resin particle dispersion A was obtained. The volume average particle diameter of the resin particles in the obtained resin particle dispersion A was 0.16 μm. Further, the solid content concentration was 32% by mass.

### Production of Colorant Particles A

2 Parts by mass of 3-(4-diethylamino-2-hexyloxyphenyl)-3-(1-ethyl-2-methylindol-3-yl)-4-azaphtalide as a leuco dye, 4 parts by mass of 1,1-bis(4′-hydroxyphenyl)hexafluoropropane and 4 parts by mass of 1,1-bis(4′-hydroxyphenyl) n-decane as color developing agents, and 50 parts by mass of a diester of 1,10-decanedicarboxylic acid and 2-(4-benzyloxyphenyl) ethanol as a decolorizing temperature control agent were uniformity dissolved by warming. 30 Parts by mass of an aromatic polyvalent isocyanate prepolymer and 40 parts by mass of ethyl acetate as encapsulating agents were mixed in the obtained mixture. The resulting solution was dispersed in 300 parts by mass of an 8% aqueous solution of polyvinyl alcohol by emulsification, and the mixture was stirred at 90° C. for about 1 hour. Thereafter, 2.5 parts by mass of a water-soluble aliphatic modified amine as a reactant was added thereto, and the resulting mixture was further stirred for 6 hours, whereby capsule particles were obtained. The dispersion of the capsule particles was put in a refrigerator (−30° C.) to develop color, whereby a colorant particles A was obtained (Tc=89° C.). The volume average particle diameter of the colorant particles in the colorant particle A was measured by SALD-7000 manufactured by Shimadzu Corporation to be 3 μm. The effective solid content concentration was 70%.

### Production of Release Agent Particle Dispersion A

In a 1-L beaker, 480 parts by mass of deionized water and 4.3 parts by mass of an aqueous solution of dipotassium alkenylsuccinate (trade name: LATEMUL ASK, manufactured by Kao Corporation, effective concentration: 28% by mass) were put, and in the resulting mixture, 120 parts by mass of carnauba wax was dispersed. The resulting dispersion liquid was further subjected to a dispersion treatment for 30 minutes using an ultrasonic homogenizer US-600T (trade name, manufactured by Nippon Seiki Co., Ltd.) while maintaining the dispersion liquid at 90 to 95° C. After cooling, deionized water was added to the dispersion liquid to adjust the solid content to 20% by mass, whereby a release agent particle dispersion A was obtained. The volume average particle diameter of the release agent particles in the obtained release agent particle dispersion A was 0.42 μm. The effective solid content concentration was 40%.

### Example 1

To 28 parts by mass of the colorant particles A, 290 parts by mass of deionized water was added and the colorant particles were sufficiently dispersed in water. 25 parts by mass of 30% ammonium sulfate solution was added to the mixture with stirring, and the mixture was kept for 1 hour. Subsequently, while stirring the resulting colorant particle dispersion, 45 parts by mass of the release agent particle dispersion A was added thereto, whereby a first aggregate dispersion liquid was produced.

Then, to the first aggregate dispersion liquid, 200 parts by mass of the resin particle dispersion A and 200 parts by mass of deionized water were fed at a constant rate over 7 hours while maintaining the temperature of the dispersion liquid at 45° C. In the process of the constant feeding, 100 parts by mass of a 30% solution of ammonium sulfate was added thereto, whereby a dispersion liquid of second aggregates having a volume average particle diameter of 7.0 μm was obtained.

Thereafter, 2.5 parts by mass of EPOCROS WS-700, a cross-linking agent manufactured by Nippon Shokubai Co., Ltd., 2.7 parts by mass of EMAL E-27C, manufactured by Kao Corporation as a dispersant, and 80 parts by mass of deionized water were added to the second aggregate dispersion liquid. Subsequently, the second aggregate dispersion liquid was heated to 65° C. and then left to stand for 2 hours to allow fusion to proceed, whereby toner particles were obtained. The volume average particle diameter of the toner particles after the fusion treatment was 10.5 μm. Thereafter, the toner particles were washed with pure water and dried until the water concentration was decreased to 1 wt % or less. Then, with respect to 100 wt % of the toner particles, 3.0 wt % of NAX 50 (SiO₂) and 0.3 wt % of NKT 90 (TiO₂), manufactured by Nippon Aerosil Co., Ltd., were externally added to the toner particles.

### Example 2

To 16 parts by mass of the colorant particles A, 290 parts by mass of deionized water was added and the colorant particles were sufficiently dispersed in water. 25 parts by mass of 30% ammonium sulfate solution was added to the mixture with stirring, and the mixture was kept for 1 hour. Subsequently, while stirring the resulting colorant particle dispersion, 45 parts by mass of the release agent particle dispersion A was added thereto, whereby a first aggregate dispersion liquid was produced.

Then, to the first aggregate dispersion liquid, 230 parts by mass of the resin particle dispersion A and 200 parts by mass of deionized water were fed at a constant rate over 7 hours while maintaining the temperature of the dispersion liquid at 45° C. In the process of the constant feeding, 100 parts by mass of a 30% solution of ammonium sulfate was added thereto, whereby a dispersion liquid of second aggregates having a volume average particle diameter of 6.8 μm was obtained.

Thereafter, 2.5 parts by mass of EPOCROS WS-700, a cross-linking agent manufactured by Nippon Shokubai Co., Ltd., 2.7 parts by mass of EMAL E-27C, manufactured by Kao Corporation as a dispersant, and 80 parts by mass of deionized water were added to the second aggregate dispersion liquid. Subsequently, the second aggregate dispersion liquid was heated to 65° C. and then left to stand for 2 hours to allow fusion to proceed, whereby toner particles were obtained. The volume average particle diameter of the toner particles after the fusion treatment was 10.5 μm. Thereafter, the toner particles were washed with pure water and dried until the water concentration was decreased to 1 wt % or less. Then, with respect to 100 wt % of the toner particles, 3.0 wt % of NAX 50 (SiO₂) and 0.3 wt % of NKT 90 (TiO₂), manufactured by Nippon Aerosil Co., Ltd., were externally added to the toner particles.

### Example 3

To 23 parts by mass of the resin particle A and 16 parts by mass of the colorant particle dispersion A, 290 parts by mass of deionized water was added and the colorant particles were sufficiently dispersed in water. 25 parts by mass of 30% ammonium sulfate solution was added to the mixture with stirring, and the mixture was kept for 1 hour. Subsequently, while stirring the resulting colorant particle dispersion, 45 parts by mass of the release agent particle dispersion A was added thereto, whereby a first aggregate dispersion liquid was produced.

Then, to the first aggregate dispersion liquid, a mixture of 207 parts by mass of the resin particle dispersion A and 200 parts by mass of deionized water was fed at a constant rate over 7 hours while maintaining the temperature of the dispersion liquid at 45° C. In the process of the constant feeding, 100 parts by mass of a 30% solution of ammonium sulfate was added thereto, whereby a second aggregate dispersion liquid was obtained.

Thereafter, 2.5 parts by mass of EPOCROS WS-700, a cross-linking agent manufactured by Nippon Shokubai Co., Ltd., 2.7 parts by mass of EMAL E-27C, manufactured by Kao Corporation as a dispersant, and 80 parts by mass of deionized water were added to the second aggregate dispersion liquid. Subsequently, the second aggregate dispersion liquid was heated to 65° C. and then left to stand for 2 hours to allow fusion to proceed, whereby toner particles were obtained. The volume average particle diameter of the toner particles after the fusion treatment was 10.5 μm. Thereafter, the toner particles were washed with pure water and dried until the water concentration was decreased to 1 wt % or less. Then, with respect to 100 wt % of the toner particles, 3.0 wt % of NAX 50 (SiO₂) and 0.3 wt % of NKT 90 (TiO₂), manufactured by Nippon Aerosil Co., Ltd., were externally added to the toner particles.

### Example 4

175 parts by mass of the resin particle dispersion A, 16 parts by mass of the colorant particle A, 12 parts by mass of the release agent particle dispersion A, and 68 parts by mass of deionized water were mixed, and then, 52 parts by mass of a 30% aqueous solution of ammonium sulfate as an aggregating agent was added thereto, and aggregation was allowed to proceed at 45° C. As a result, first aggregates having a volume average particle diameter of 5.5 μm were obtained.

Subsequently, to a dispersion liquid of the first aggregates, a mixture of 88 parts by mass of the resin particle dispersion A and 90 parts by mass of deionized water was continuously fed for 10 hours, whereby second aggregates were obtained.

Thereafter, 2.5 parts by mass of EPOCROS WS-700, a cross-linking agent manufactured by Nippon Shokubai Co., Ltd., 62.7 parts by mass of EMAL E-27C, manufactured by Kao Corporation as a dispersant, and 500 parts by mass of deionized water were added thereto, and the resulting mixture was heated to 65° C. and then left to stand for 2 hours to allow fusion to proceed, whereby toner particles were obtained. The volume average particle diameter of the obtained toner particles was 6.8 μm. Thereafter, washing, drying, and external addition were performed in the same manner as in Example 1, whereby a toner was produced.

### Comparative Example 1

265 parts by mass of the resin particle dispersion A, 16 parts by mass of the colorant particle A, 12 parts by mass of the release agent particle dispersion A, and 160 parts by mass of deionized water were mixed, and then, 52 parts by mass of a 30% aqueous solution of ammonium sulfate as an aggregating agent was added thereto, and aggregation was allowed to proceed at 45° C.

Thereafter, 2.5 parts by mass of EPOCROS WS-700, a cross-linking agent manufactured by Nippon Shokubai Co., Ltd., 62.7 parts by mass of EMAL E-27C, manufactured by Kao Corporation as a dispersant, and 500 parts by mass of deionized water were added to the obtained aggregate dispersion liquid. Subsequently, the aggregate dispersion liquid was heated to 65° C. and then left to stand for 2 hours to allow fusion to proceed, whereby toner particles were obtained. The volume average particle diameter of the toner particles after the fusion treatment was 7.5 μm. Thereafter, washing, drying, and external addition were performed in the same manner as in Example 1.

### Comparative Example 2

231 parts by mass of the resin particle dispersion A, 16 parts by mass of the colorant particle A, 12 parts by mass of the release agent particle dispersion A, and 68 parts by mass of deionized water were mixed, and then, 52 parts by mass of a 30% aqueous solution of ammonium sulfate as an aggregating agent was added thereto, and aggregation was allowed to proceed at 45° C. As a result, first aggregates having a volume average particle diameter of 5.5 μm were obtained.

Subsequently, to a dispersion liquid of the first aggregates, a mixture of 34 parts by mass of the resin particle dispersion A and 90 parts by mass of deionized water was continuously fed for 10 hours, whereby second aggregates were obtained.

Thereafter, 2.5 parts by mass of EPOCROS WS-700, a cross-linking agent manufactured by Nippon Shokubai Co., Ltd., 62.7 parts by mass of EMAL E-27C, manufactured by Kao Corporation as a dispersant, and 500 parts by mass of deionized water were added to the obtained aggregates. Subsequently, the resulting mixture was heated to 65° C. and then left to stand for 2 hours to allow fusion to proceed. The volume average particle diameter of the obtained toner particles was 6.8 μm. Thereafter, washing, drying, and external addition were performed in the same manner as in Example 1, whereby a toner was produced.

### Comparative Example 3

265 parts by mass of the resin particle dispersion A, 16 parts by mass of the colorant particles A, 12 parts by mass of the release agent particle dispersion A, and 500 parts by mass of deionized water were mixed, whereby a uniform dispersion liquid was produced. By spray-drying this dispersion liquid, a powder having a volume average particle diameter of 10.3 μm was obtained. Thereafter, external addition was performed in the same manner as in Example 1. As a result of SEM observation, the colorant particles were completely separated from the toner particles.

### Comparative Example 4

800 parts by mass of the amorphous polyester resin A, 150 parts by mass of the colorant particles A, and 50 parts by mass of carnauba wax were mixed, and the resulting mixture was sufficiently kneaded using a kneader. The resulting kneaded material was pulverized by a pulverizer, followed by classification, whereby a powder having a volume average particle diameter of 9.5 μm was obtained. Thereafter, external addition was performed in the same manner as in Example 1. It was confirmed by SEM observation that the capsules of the colorant particles were crushed. It was also confirmed that the colorant particles did not exhibit the coloring-decolorizing performance.

### Preparation of Developer

A developer was produced by mixing each of the obtained toners of Examples and Comparative Examples with a ferrite carrier coated with a silicone resin or the like so that the concentration of the toner was 8%.

### Image Formation

An image was obtained on a sheet of ppc paper (P-50s) manufactured by Toshiba Corporation using MFP (e-STUDIO 4520C), manufactured by Toshiba Tec Corporation, in which the temperature of the fixing device was adjusted to 85° C. and the paper feed speed was adjusted to 40 mm/sec.

### Measurement of Image Density

In the measurement of an image density, a reflection densitometer (RD-19I) manufactured by GretagMacbeth Ltd. was used. In the measurement, a chart in which square patches of 1.0 cm² were arranged in 15 rows perpendicularly to the conveying direction and in 20 rows in parallel to the conveying direction was used, and the measurement was performed for the 300 square patches using the reflection densitometer, and an average of the measurements was used as an image density.

All of the images formed using the toners of Examples 1 to 3 had a higher image density than those formed using the toners of Comparative Examples 1 to 3.

### Confirmation of Decolorizing Performance

A paper medium having a colored image formed thereon with each of the toners of Examples was conveyed at a paper feed speed of 100 mm/sec using MFP (e-STUDIO 4520C), manufactured by Toshiba Tec Corporation, in which the temperature of the fixing device was set to 100° C.

It was confirmed that the image formed using each of the toners of Examples can be erased by the treatment.

While certain embodiments have been described, these embodiments have been presented by way of example only, and are not intended to limit the scope of invention. Indeed, the novel toner and method described herein may be embodied in a variety of other forms; furthermore, various omissions, substitutions and changes in the form of the toner and method described herein may be made without departing from the spirit of the inventions. The accompanying claims and their equivalents are intended to cover such forms or modifications as would fall within the scope and spirit of the inventions.

As described in detail above, according to the technique described in this specification, a technique capable of providing excellent color developability and also instantaneously erasing formed images can be provided.

What is claimed is:

1. A decolorizable electrophotographic toner comprising:
toner particles,
the toner particle comprising:
a binder resin; and
colorant particle which contain an electron donating color developable agent, an electron accepting color developing agent, and a decolorizing temperature control agent, and have a capsule structure coated with an outer shell, wherein
the ratio of an total exposed areas of the colorant particles to the total projected areas of the toner particles calculated on the basis of scanning electron microscope (SEM) observation of the toner is 5.0% or less.

2. The toner according to claim 1, wherein the toner has a volume average particle diameter of 5 to 20 μm.

3. The toner according to claim 1, wherein the colorant particles have a volume average particle diameter of 0.5 to 5.0 μm.

4. The toner according to claim 1, wherein the binder resin is a polyester resin.

5. A method for producing a decolorizable electrophotographic toner comprising:
mixing a colorant particle dispersion, a release agent particle dispersion, and a resin particle dispersion, and aggregating the colorant particles, the release agent particles, and the resin particles in the obtained dispersion of the colorant particles, the release agent particles, and the resin particles, thereby producing first aggregates containing the colorant particles and the release agent particles as main components; and
mixing the resin particle dispersion in a dispersion containing the obtained first aggregates, and aggregating the first aggregates and the resin particles in the obtained dispersion of the first aggregates and the resin particles to coat the first aggregates with the resin particles, thereby producing second aggregates, wherein
the amount of the resin particles to be used for producing the first aggregates with respect to the amount of the total resin particles is 15% or less.

6. A method for producing a decolorizable electrophotographic toner comprising:
mixing a colorant particle dispersion, a release agent particle dispersion, and a resin particle dispersion, and aggregating the colorant particles, the release agent particles, and the resin particles in the obtained dispersion of the colorant particles, the release agent particles, and the resin particles, thereby producing first aggregates containing the resin particles as main components; and
mixing the resin particle dispersion in a dispersion containing the obtained first aggregates, and aggregating the first aggregates and the resin particles in the obtained dispersion of the first aggregates and the resin particles to coat the first aggregates with the resin particles, thereby producing second aggregates, wherein
the amount of the resin particles to be used for producing the first aggregates with respect to 100 parts by mass of the resin particles to be used for producing the second aggregates is 100 to 200 parts by mass.

7. A cartridge, comprising the toner according to claim 1.

8. An image forming apparatus, comprising the toner according to claim 1.
